(19) United States
(12) Patent Application Publication
(10) Pub. No.: US 2007/0199259 A1
(43) Pub. Date: Aug. 30, 2007

(54) Secondary window with vacuum valve and alarm

(76) Inventor: Andrew J. Parsley, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/360,895

(22) Filed: Feb. 24, 2006

(51) Int. Cl. G08B 13/08; E06B 7/00; E06B 3/68; E06B 3/28

(52) U.S. Cl. 52/203; 49/57; 340/545.1

(57) ABSTRACT

A secondary window covering is disclosed. The window covering can be placed on the interior or exterior of an existing windows. The covering is configurable to windows or nearly any shape including rectangular, arched or round. The covering provides additional thermal protection, security and tinting. A magnetic seal secures one or more secondary window coverings to the existing window. An alarm system can be incorporated into the secondary window to provide additional security. A valve is incorporated into the window or frame to fill the area between the existing window and the secondary window with gas, or vacuum the area between the existing window and the secondary window. The construction of the secondary window allows the secondary window to be easily removed and reinstalled when required for seasonal or year long protection.

### FIELD OF THE INVENTION

This invention relates to a secondary covering for a window. More particularly, the present invention relates to a secondary window or window covering that can be placed over an existing window that provides additional thermal protection, security and tinting. The invention also provides a covering that is easy to remove and re-install.

### BACKGROUND OF THE INVENTION

The majority of heat lost from a closed room or building is from the windows. In addition to losing heat in the winter time through a window, windows can also allow heat from the sun to shine through a window causing increased air conditioning costs. Windows also provide an access point where someone can break into to rob a house. Windows are also fragile and can easily be broken from intrusion of balls or other objects. One of the easiest methods to solve these problems is by installing a secondary window over an existing window to create an insulating air pocket between the windows. It may be desirable to utilize the secondary window at only limited times of the year, making the removability and re-installation simple.

A number of patents have issued that provide for the use of thin plastic sheeting that is stretched across a wooden or metal frame. Exemplary examples of these patents are shown and described in U.S. Pat. No. 5,737,885 issued to Stoyke on Apr. 14, 1998, U.S. Pat. No. 4,453,585 issued to Ruggerberg, Sr. et al on Jun. 12, 1984, U.S. Pat. No. 4,193,235 issued to Cicchiara on Mar. 18, 1980 and U.S. Pat. No. 4,189,880 issued to Ballin on Feb. 26, 1980. While these patents describe a frame or multiple frame structures with a secondary window covering, none of them disclose securing the secondary window with magnets, nor do they disclose the use of an alarm function with the window or the use of a valve to fill or evacuate the area between the existing window and the replacement window.

U.S. Pat. No. 4,399,640 issued to Porter on Aug. 23, 1983 and U.S. Pat. No. 4,271,566 issued to Perina on Jun. 9, 1981 both disclose a first frame structure that is secured to an existing window and a second frame structure that is secured to the secondary window. This arrangement allows the secondary window to be easily removed and re-installed with little effort. While these patents describe a frame or multiple frame structures with a secondary window covering, none of them disclose securing the secondary window with magnets, nor do they disclose the use of an alarm function with the window or the use of a valve to fill or evacuate the area between the existing window and the replacement window.

U.S. Pat. No. 4,649,681 issued to Eisele on Mar. 17, 1987 discloses a multi-paneled window covering for providing additional thermal protection to an existing window. The window covering disclosed consists of three successive stagnant air spaces to provide additional window insulation. This patent discloses multiple air pockets, but the patent does not allow for just one or two air pockets. This patent does not disclose securing the secondary window with magnets, nor does it disclose the use of an alarm function with the window or the use of a valve to fill or evacuate the area between the existing window and the replacement window.

What is needed is a secondary window that can be removed and reinstalled with minimal effort. The ideal secondary window would be secured with magnets to hold one or multiple secondary windows onto the existing window. The secondary window would also include an alarm function to signal tampering or breaking of the window and further include a valve to fill or evacuated the area between the two windows.

### BRIEF SUMMARY OF THE INVENTION

It is an object of the secondary window to provide a window that can easily be removed and reinstalled with minimal effort. The proposed secondary window satisfies this requirement by providing a window that is secured with one or more magnets or magnetic strips. The magnets exist both on a frame that is secured to an existing window or may simply be installed with adhesive placed on the back of the magnet. Because of the nature of magnets, multiple secondary windows can be stacked upon each other to provide even greater insulation. This allows secondary windows with different properties can be utilized on the same window.

It is another object of the secondary window to provide an alarm function to the secondary window. The alarm function sounds when the secondary window detects tampering or breaking. This is particularly beneficial to provide security to a house that was not built with an alarm. The detection and sounding functions can be integrated within the frame, or the detection can transmit a signal to a central location that identifies the window that is tampered and sounds an alert.

It is another object of the secondary window to provide a window with insulation, thermal, tinting, security, protection, sound, privacy and other functions to an existing window that may only have a single pain glass window.

It is another object of the secondary window to provide a window with cosmetic features such as panes or stained glass appearance. These features can be bonded to the secondary window for aesthetic benefit as well as providing the protection features available when using just the secondary window.

It is another object of the secondary window to provide a valve in the frame or window to allow the area between the window and the secondary window to be filled with inert gas or vacuumed to change the insulation properties. A tinting or UV gas can fill the gap and provide additional benefit.

It is another object of the secondary window is to provide a window that can be used either on the inside or outside of the window. When the secondary window is placed on the outside of an existing window it can provide protection from balls or other objects that can strike the existing window and cause harm. The secondary window can be made from a resilient tinted plastic to provide impact protection, UV protection and insulation properties.

Still another object of the secondary window is to provide a secondary window that can be made to fit nearly any shape. This is especially desirable with newer houses that can be a combination of rectangular, arched, irregular and round windows.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a secondary window installed on an existing window on the outside of a house.

FIG. 2 shows a secondary window installed on an existing window on the inside of a house.

FIG. 3 shows a secondary window installed on an arch shaped existing window on the inside of a house.

FIG. 4 shows a cross sectional side view of multiple secondary windows installed inside and outside of an existing window.

### DETAILED DESCRIPTION

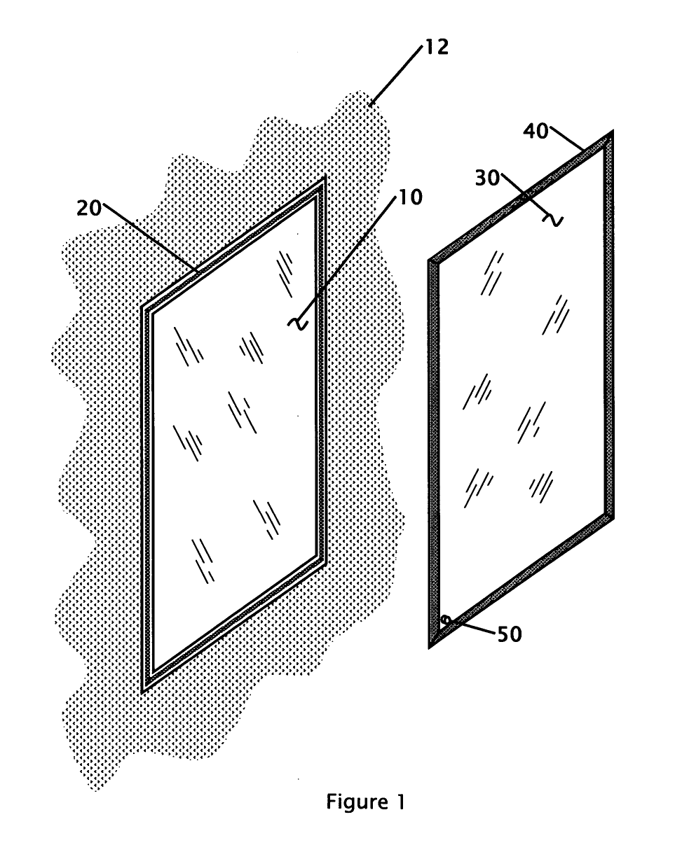

FIG. 1 shows a secondary window installed on an existing window on the outside of a house. The outside of the house 12 is shown as stucco covering the wall of a house. The existing window 10 is shown as a standard window that exists on most houses or buildings. In the preferred embodiment a strip of magnetic tape 20 is placed around the exterior edge of the window where the frame holds the window. It is also contemplated that the magnetic strip can be placed on the window itself. The magnetic strip is supplied with an adhesive backing with a release liner and a homeowner or installer can lay the magnetic strip onto the area around the window, cut the strip to the desired size or shape. Remove the release liner and apply the magnetic strip to a clean surface to create a frame structure that is secured to the existing window. The secondary window comprises a rigid or flexible material 30 that is fabricated in a size that is similar to the size and shape of the existing window 10. It is contemplated that this secondary window is fabricated from a transparent or semi-transparent material such as but not limited to glass, Polycarbonate, Acrylic, PETG, and PVC. A magnetic frame 40 made from magnetic strip material is joined to the secondary window 30. The magnetic strip is supplied with an adhesive backing with a release liner and a homeowner or installer can lay the magnetic strip onto the area around the secondary window, cut the strip to the desired size or shape. Remove the release liner and apply the magnetic strip to a clean surface to create a frame structure that is secured to the secondary window. The magnetic surfaces 20 and 40 are brought in proximity with each other and the magnets will maintain the secondary window in a planar relationship with the existing window.

The secondary window can be removed by pulling on a corner, side or edge of the secondary window to break the magnetic bond. The removal allows for cleaning maintenance and opening of the existing window. Both sides of the secondary window can also be cleaned, and reinstallation of the secondary window is accomplished by bringing the magnetic surfaces 20 and 40 in proximity to each other until they magnetically attract. A valve 50 allows venting of any air that is trapped between the two windows, vacuuming air from between the two windows and or filling the area between the two windows with a gas such as argon or others that improve the insulation properties of the air space between the two windows.

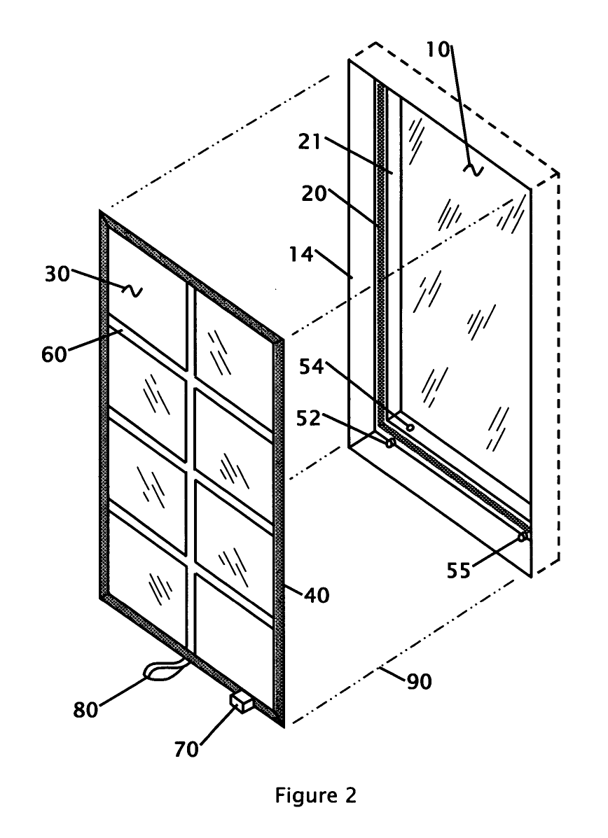

FIG. 2 shows a secondary window installed on an existing window on the inside of a house. In this figure the secondary window 30 is placed on the inside of a house on an existing window 10. The window on the inside of a house is often recessed 14 into an exterior wall, and the installation of the secondary window is also be placed within the recess. The magnetic strip is placed on the frame of the existing window. In the embodiment shown a frame 21 is constructed and placed within the recessed opening and the magnetic strip 20 is placed around the frame structure. The secondary window 30 is constructed to fit inside the recess 14. A magnetic strip 40 surrounding the secondary window creates a window frame. It is also contemplated that the secondary window can be placed within a metallic or other rigid frame structure. If the frame structure of the secondary window is constructed of a ferrous material the frame will provide the attraction to the magnetic strip 20 on the existing window. In the embodiment shown the secondary window includes dividers 60 that provide windows that appear to have panes. It is also contemplated that the secondary window can be detailed with tinting, images or other materials to provide tinting, privacy, thermal insulation, sound insulation or intrusion protection properties.

When installing the secondary window into a recess where the existing window is located, the bottom of the secondary window is placed on top of valve 52 and an equally located stub 55 that is provided so the secondary window can be placed on the valve and stub to aid in locating the secondary window on the existing window. While a valve and stub are shown in this figure, the requirement for these components is not essential. Once the second window is installed into the recess 14, the ability to remove the secondary window from the recess is limited. A strap 80 or similar removal item is placed on the bottom (as shown) edge or side of the secondary window to provide a means to easily remove the secondary window from the existing window. Once the strap 80 is pulled the magnetic bond between the existing and secondary window is broken and the secondary window can easily be removed from the recess.

The valve 52 is integrated into the frame 21 and terminates at an opening 54 between the existing window and the secondary window. This allows filling the area with a gas or vacuuming the air from the area between the two windows. While the valve in both FIGS. 1 and 2 show the valve located in the lower portion of the window or frame, the location of the valve can be located in any position on the window or window frame. It is also contemplated that two or more valves can be used where one is used to vacuum out the cavity while the other is used to fill the cavity. In one extreme contemplated embodiment the area between the two windows can be filled with foam beads to provide both insulation and view obstruction without significantly compromising light transmission into a room.

A tamper alarm device 70 is shown installed on the secondary window. The alarm can exist as a stand alone alarm that is activated and sounds when the secondary window is tamper or broken. In another contemplated embodiment the alarm transmits a wireless signal to a central alarm location where an alarm for the entire house or building is located.

In another contemplated embodiment the secondary window can be placed on the wall surface on the inside of the house. In this contemplated embodiment the frame is secured to the wall, and the secondary window is sufficiently sized to fit over the window recess.

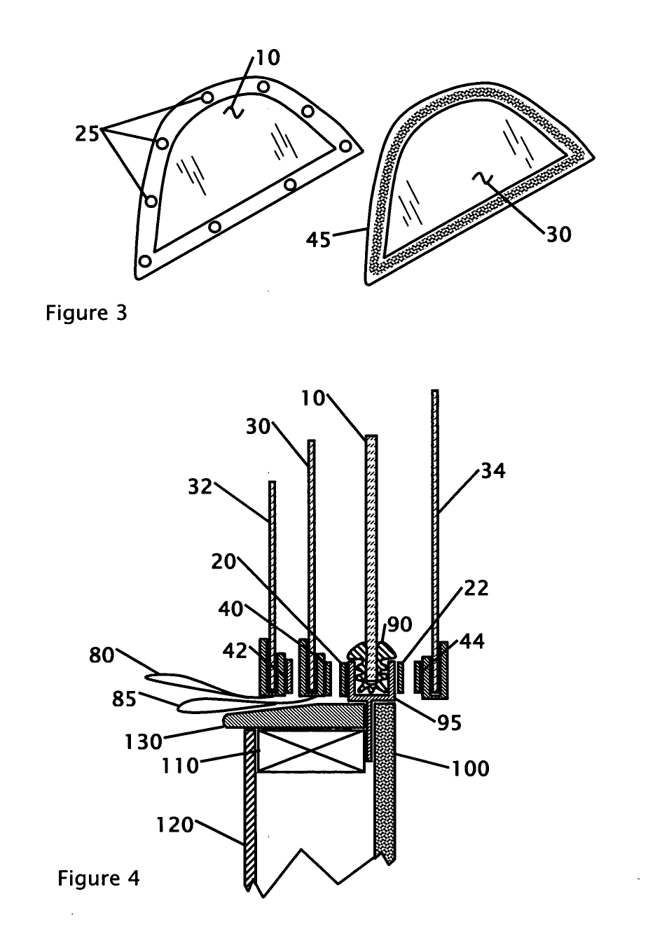

FIG. 3 shows a secondary window installed on an arch shaped existing window on the inside of a house. In this figure the existing window 10 is arched in shape. Because the window is arched in shape the use of magnetic strip material is more difficult to form around the arch of the window. Individual magnets 25 are placed at intervals around the existing window. The individual magnets are held onto the frame because they are adhesively backed or because they are bonded with glue or other similar bonding method. The secondary window 30 is configured with a metallic frame 45 that is magnetically attracted to the magnets 25.

FIG. 4 shows a cross sectional side view of multiple secondary windows installed inside and outside of an existing window. The existing window 10 is shown located within the frame 22. An elastomeric seal 90 holds the existing window 10 within the frame 95 that is secured to a house. The window frame 95 is shown resting on a window sill 130 on a 2×4 or similar house construction stud 110. Stucco or other exterior housing covering 100 on the outside of the house covers the exterior wall and seals the bottom of the window frame 95. Drywall or other similar interior housing material 120 seals the interior of the wall 120.

One secondary window 34 is shown located on the outside of the existing window 10, and two secondary windows 30 and 32 are shown located on the inside of the existing window 10. Magnetic strip material 22 is placed on the exterior of the frame 95 of the existing window 10. Secondary window 34 has magnetic strip material 44 placed on the outer portion of the secondary window. The magnetic materials 22 and 44 attract to each other and exterior window 34 is maintained on the exterior of existing window 10. It is contemplated that this exterior window provides protection from abrasions that may be caused by blowing sand or debris. It is further contemplated that the secondary exterior window provides protection from larger objects such as golf balls, rocks, or other objects that can break a glass window, but will bounce off a plastic secondary window.

Two secondary windows 30 and 32 are shown on the interior of the existing window 10. Each additional window creates an additional air pocket that improves insulation of the window and reduces heat loss. A magnetic strip 20 is placed in the frame 95 of the existing window 10. A magnetic or metal strip 40 is located on one of the interior secondary windows. A magnetic strip 42 on another, or subsequent, secondary windows 32, sandwich additional secondary windows to the existing window 10. Each of the secondary windows has a strap 80 and 85 to allow for easier removal of the secondary interior windows that may exist inside a recessed window. It is contemplated that each secondary window provides a different purpose, as an example, window 34 can provide abrasion, security and impact protection, window 30 can provide filtering of harmful sunlight, while window 32 provides sound insulation. Window 32 may also include the alarm signaling mechanism that warns of tampering or breaking of the window. One or all of the secondary windows can be easily removed from and reinstalled onto the existing window with minimal effort. The secondary windows can be stored when their function is no longer required, leaving the magnetic strips in place for future installation.

In another contemplated embodiment the secondary windows are constructed from a thin plastic film. The film is placed between the two magnets stretched prior to trimming the thin plastic film.

Thus, specific embodiments of a secondary window have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A magnetically secured secondary window comprising:
an existing window with at least one magnet attached to the window or window frame wherein;
an at least semi-transparent supplemental window with a frame having a magnetic member wherein;
when the magnetic member in the supplemental frame is brought into proximity with the magnetic member attached to the existing window the supplemental window is retained in an essentially planar relationship with the existing window.

2. A magnetically secured secondary window according to claim 1 in which the magnetic members comprise strip magnets.

3. A magnetically secured secondary window according to claim 1 in which the at least semi-transparent supplemental window includes properties to provide tinting, privacy, thermal insulation, sound insulation or intrusion protection.

4. A magnetically secured secondary window according to claim 1 in which multiple secondary semi-transparent supplemental windows can be stacked upon each other or placed both inside and or outside of the existing window.

5. The magnetically secured secondary window according to claim 1 that further includes a valve means fitted into the secondary window or the frame to fill with gas and or vacuum the area between the semi-transparent window and the existing window.

6. The magnetically secured secondary window according to claim 1 that further includes a tamper detection and notification function to identify that the secondary window has been tampered with.

7. A secondary window with an alarm comprising:
a frame structure with an at least semi-transparent window fitted to the frame structure wherein;
the frame structure is securable to an existing window;
a signaling apparatus that is integrated within the frame structure to provide alarm notification when the at least semi-transparent window has been tampered with.

8. A secondary window with an alarm according to claim 7 in which the frame structure of the at least semi-transparent window is held to an existing window with at least one magnet.

9. The secondary window from claim 8 in which the at least one magnetic is comprise at least one strip magnet.

10. A secondary window with an alarm according to claim 7 in which the at least semi-transparent supplemental window includes properties to provide tinting, privacy, thermal insulation, sound insulation or intrusion protection.

11. A secondary window with an alarm according to claim 7 in which multiple secondary semi-transparent supplemental windows can be stacked upon each other or placed both inside and outside of the existing window.

12. The secondary window with an alarm according to claim 7 that further includes a valve means fitted into the secondary window or the frame to fill with gas and or vacuum the area between the semi-transparent window and the existing window.

13. The secondary window with an alarm according to claim 7 that further includes an integrated tamper detection and notification function to identify that the secondary window has been tampered or broken.

14. A secondary window with valve comprising:
a frame structure with an at least semi-transparent window fitted to the frame structure where the frame structure is securable to an existing window or window frame;
a valve fitting in the frame or in the semi-transparent window such that;
when the frame structure with the at least semi-transparent window is secured to the existing window the valve fitting is used to fill with gas and or vacuum the area between the semi-transparent window and the existing window.

15. A secondary window with valve according to claim 14 in which the frame structure of the at least semi-transparent window is held in proximity to an existing window with at least one magnet.

16. A secondary window with valve according to claim 14 in which the at least one magnetic is comprise at least one strip magnet.

17. A secondary window with valve according to claim 14 in which at least the semi-transparent supplemental window includes properties to provide tinting, privacy, thermal insulation, sound insulation or intrusion protection.

18. A secondary window with valve according to claim 14 in which multiple secondary semi-transparent supplemental windows can be stacked upon each other or placed both inside and or outside of the existing window.

19. The secondary window with valve according to claim 14 that further includes a tamper detection and notification function to identify that the secondary window has been tampered with.

20. The secondary window with valve according to claim 14 in which the gas that fills the area between the secondary window and the existing window provides thermal, tinting, privacy or insulating properties.
